(19) United States
(12) Patent Application Publication
(10) Pub. No.: US 2025/0348362 A1
(43) Pub. Date: Nov. 13, 2025

(54) OVER SUBSCRIBE SAAS WHILE MITIGATING NOISY NEIGHBORS

(71) Applicant: Red Hat, Inc., Raleigh, NC (US)

(72) Inventors: Leigh Griffin, Waterford (IE); David Ffrench, Waterford (IE)

(21) Appl. No.: 18/662,661

(22) Filed: May 13, 2024

(51) Int. Cl. G06F 9/50

(52) U.S. Cl. CPC G06F 9/5044; G06F 9/5083

(57) ABSTRACT

Systems and methods are provided. An example method can include obtaining, by a computing system comprising one or more computing devices, first time series data indicative of a plurality of amounts of a computing resource used at a first plurality of times by a first service instance executing on a first cluster of computing devices. The example method can include obtaining, by the computing system, second time series data indicative of a plurality of amounts of the computing resource used at a second plurality of times by one or more processes executing on a second cluster of computing devices. The example method can include migrating, by the computing system based on a comparison between the first time series data and the second time series data, the first service instance to the second cluster of computing devices.

### BACKGROUND

Software as a service (SAAS) is a computing service, wherein a computing system comprising one or more computing devices can perform computing operations (e.g., operations requested by a requester, etc.). In some instances, a computing system may be divided (e.g., physically divided, logically divided, etc.) into clusters of computing devices. Each cluster may have access to an amount of various computing resources, such as virtual or physical computing devices, processor devices, volatile memory, non-volatile storage space, and the like.

### SUMMARY

The present disclosure is generally directed to systems and methods for allocating computing processes to clusters of computing devices based on the processes' usage of computing resources.

In one implementation, a method is provided. The method includes obtaining, by a computing system comprising one or more computing devices, first time series data indicative of a plurality of amounts of a first computing resource used at a first plurality of times by a first service instance executing on a first cluster of computing devices. The method further includes obtaining, by the computing system, second time series data indicative of a plurality of amounts of the first computing resource used at a second plurality of times by one or more first processes executing on a second cluster of computing devices. The method further includes migrating, by the computing system based on a comparison between the first time series data and the second time series data, the first service instance to the second cluster of computing devices.

In another implementation, a computing system is provided. The computing system includes one or more computing devices to obtain first time series data indicative of a plurality of amounts of a first computing resource used at a first plurality of times by a first service instance executing on a first cluster of computing devices. The one or more computing devices are further to obtain second time series data indicative of a plurality of amounts of the first computing resource used at a second plurality of times by one or more first processes executing on a second cluster of computing devices. The one or more computing devices are further to migrate, based on a comparison between the first time series data and the second time series data, the first service instance to the second cluster of computing devices.

In another implementation, a non-transitory computer-readable storage medium is provided. The non-transitory computer-readable storage medium includes executable instructions to cause a processor device to obtain first time series data indicative of a plurality of amounts of a first computing resource used at a first plurality of times by a first service instance executing on a first cluster of computing devices. The instructions further cause the processor device to obtain second time series data indicative of a plurality of amounts of the first computing resource used at a second plurality of times by one or more first processes executing on a second cluster of computing devices. The instructions further cause the processor device to migrate, based on a comparison between the first time series data and the second time series data, the first service instance to the second cluster of computing devices.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2 is a flowchart diagram of a method for migrating a service instance between clusters of computing devices based on computing resource usage data;

FIG. 3 is a simplified block diagram of the environment illustrated in FIG. 1 according to one implementation; and

FIG. 4 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Software as a service (SAAS) is a computing service in which a computing system can perform various computing operations (e.g., for various users). In some instances, each computing operation or group of operations may be allocated an amount of computing resources to be made available to perform the operations, such as an amount of memory, processor devices, storage space, etc. However, the amount allocated can sometimes be greater than an amount needed to perform the operations, which can cause computing resources to be wasted. For example, a computing operation may be allocated an amount of computing resources based on an expected peak usage amount (e.g., during peak business hours, etc.), and may use significantly less than the allocated amount during off-peak periods. In some instances, this can cause the allocated computing resources to be left idle (e.g., on standby, etc.) instead of being used productively.

The examples set forth below can assign processes to computing resources in a manner that can improve the allocation of computing resources and improve the efficiency of a computing system. For example, in some instances, an amount of idle computing resources can be reduced by “oversubscribing” processes to a computing device or group of devices. For example, the amount of computing resources allocated to the processes can be greater than the total amount of computing resources available to the devices.

However, in some instances, naively oversubscribing can cause a shortage of computing resources, which can prevent computing processes from being properly executed. Such a shortage can be referred to as a “noisy neighbor” problem, because processes using large amounts of computing resources can act as “noisy neighbors” that may prevent other processes from executing or otherwise disrupt processes running on the same device or group of devices.

The examples set forth below can “oversubscribe” processes while mitigating the “noisy neighbor” problem. For example, a computing system can monitor the usage of various computing resources by computing operations across multiple clusters of computing devices. In some instances, the computing system can track the usage amounts over time. Based on the tracked usage data, the computing system can predict the amount of each computing resource that each computing operation will use at any given future time. Predicting future usage can include, for example, identifying time-based patterns in the tracked usage data, such as daily patterns and weekly patterns. For example, a computing operation associated with a business or office located in Europe may experience peak usage on weekdays at a first time of day, and a computing operation associated with a North American office may experience peak usage on weekdays at a different time of day.

Based on the predicted future usage, the computing system can assign each computing operation to an optimal cluster of computing devices. For example, the computing system can obtain data indicating how much of each computing resource (e.g., memory, processor devices, etc.) a cluster has available in total. The computing system can then compare the total amounts of available resources to the predicted usage amounts for processes assigned to the cluster at various future times. Based on the comparison, the computing system can determine how much of each computing resource is expected to be available at various future times. The computing system can then migrate processes between clusters to optimize resource usage in each cluster. For example, the computing system can determine what computing resources are predicted to be available on a cluster, and can add a new process whose predicted usage closely matches the predicted availability. In this manner, for instance, a process can be assigned to a “best fit” cluster whose available computing resources most closely match the needs of the process.

The examples set forth below provide a variety of technical effects and benefits, such as reduced computational costs for some computing operations. For example, the examples set forth below can improve the allocation of computing processes to hardware resources, enabling a computing system to execute computing processes using fewer clusters, fewer computing devices, less hardware, and the like. Additionally, the examples set forth below can prevent wasted computational costs (e.g., electricity costs, etc.) associated with idle computing devices. For example, some alternative methods of providing software as a service may leave idle computing devices in a standby mode, thereby consuming electricity even when the idle devices are not performing any operations. As another example, some alternative methods may operate a large number of computing devices, with each computing device having some hardware resources (e.g., memory, processor, etc.) that may be idle while the computing device is running. In contrast, the examples set forth below can more fully utilize computing devices and hardware resources compared to alternative methods, thereby allowing the same number of computing processes to be executed on a smaller number of computing devices. Using a smaller number of computing devices can reduce various costs associated with running the computing processes, including electricity costs, hardware costs, and the like. In this manner, for instance, the examples set forth below can improve the functioning of a computing system by enabling operations to be performed at reduced computational cost.

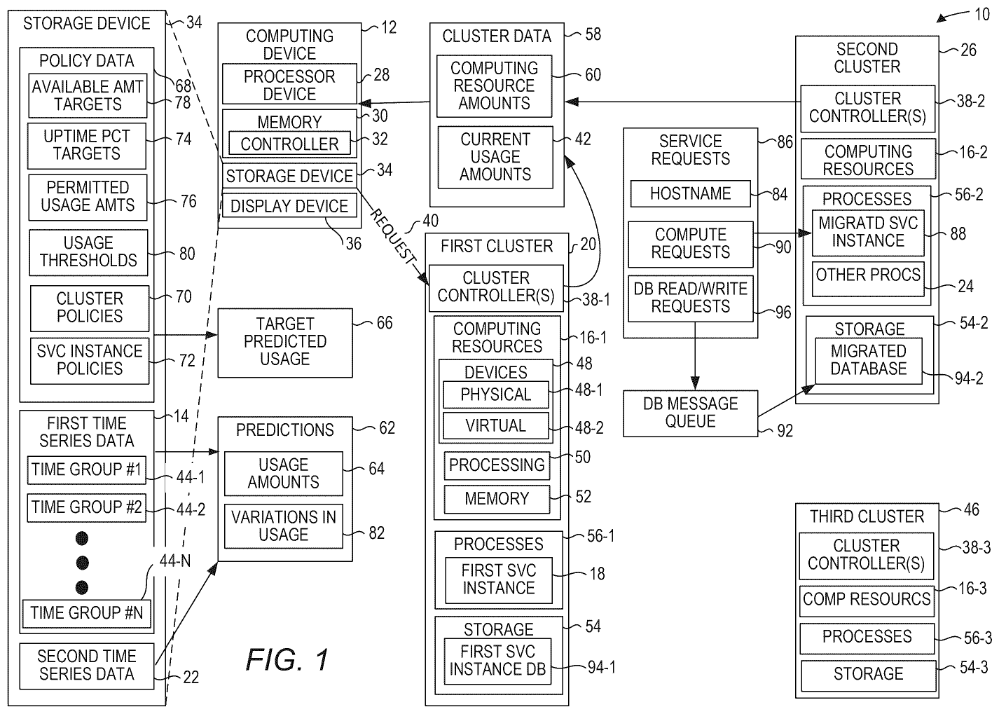

FIG. 1 is a block diagram of an environment in which examples disclosed herein may be practiced. A computing system 10 can comprise one or more computing devices 12. A computing device 12 can obtain first time series data 14 indicative of a plurality of amounts of usage of one or more computing resources 16-1 by a first service instance 18 running on a first cluster 20 of computing devices. The computing device 12 can obtain second time series data 22 indicative of a plurality of amounts of usage of one or more computing resources 16-2 by one or more second processes 24 running on a second cluster 26 of computing devices. Based on the comparison, the computing device 12 can migrate the first service instance 18 to the second cluster 26.

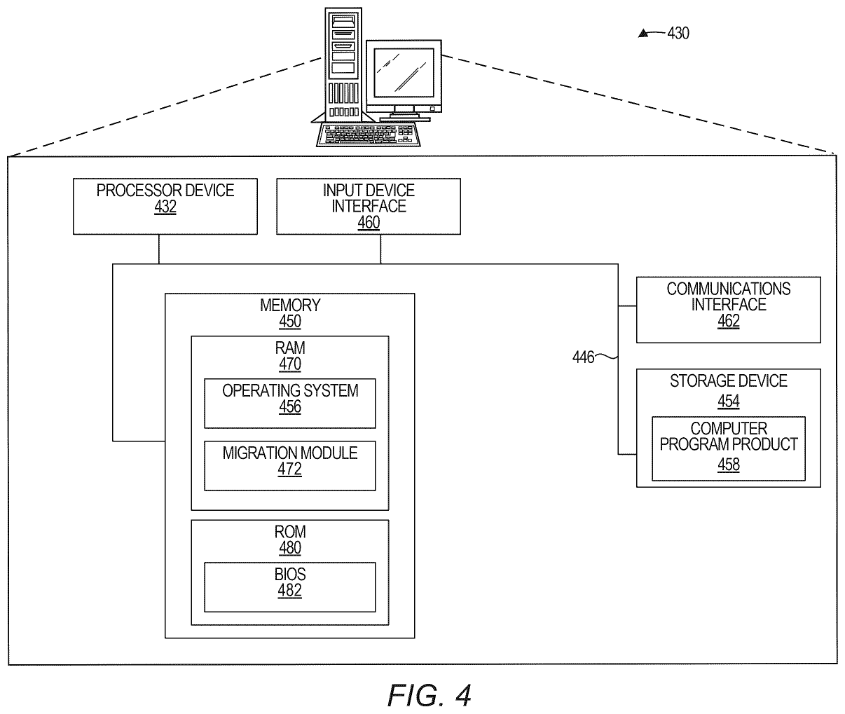

A computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 28, memories 30 comprising a memory controller 32, storage devices 34, or display devices 36. In some implementations, a computing device 12 can include a client device or a server device. Additional example implementation details for a computing device 12 are provided below with respect to FIG. 4.

First time series data 14 can include, for example, a plurality of data items, with each data item being associated with a time. A time can include, for example, a time window (e.g., 30 seconds, one minute, five minutes, one hour, etc.) or timestamp. Each data item of the first time series data 14 can include, for example, data indicative of an amount of one or more computing resources 16-1 (e.g., devices, memory, processing, ingress, egress, disk input/output, etc.) used by the first service instance 18 at an associated time.

In some instances, obtaining the first time series data 14 can include querying a cluster controller 38 of the first cluster 20. For example, a computing device 12 can send, at each of a plurality of times (e.g., every 30 seconds, every minute, every five minutes, every hour, etc.), a request 40 to the cluster controller 38 for usage data associated with the computing resources 16-1. Responsive to each request 40, the cluster controller 38 can send data indicative of current usage amounts 42 to the computing device 12. In some instances, a request 40 can include an application programming interface (API) request. In some instances, a request 40 can include a request for receiving usage metrics associated with a container deployment system (e.g., Kubernetes, etc.). By way of non-limiting example, in the context of a Kubernetes container deployment system, a request 40 can include a kube-state-metrics request, a kubelet-metrics-server request, a kubelet-instrumentation request, or the like. Similar requests 40 are available in other contexts. For example, in other contexts, a request 40 can include any request (e.g., query, API call, etc.) for retrieving any usage metric data corresponding to a type of usage metric (e.g., memory usage, processor usage, etc.) that can be retrieved with a kube-state-metrics, kubelet-metrics-server, or kubelet-instrumentation request.

A container deployment system can be, for example, a system for deploying or otherwise operating (e.g., initiating, scheduling, managing, controlling, etc.) containers. A container is an isolated operating environment that typically includes a running instance of an application and any dependencies needed for the application to run. A container can be initiated from a container image, which is a standalone executable package of software that includes everything needed to run an application. A container image typically includes an application and one or more dependencies needed for the application to run, such as system tools, system libraries, and the like. A container build file is a file comprising one or more instructions for building a container image.

Containerization technologies, such as, by way of non-limiting example, Docker container technology, Kubernetes container technology, CoreOS (Rocket) container technology, Tectonic container technology, and the like, are increasingly popular due, in part, to their relatively low resource requirements compared to other process isolation mechanisms, such as virtual machines. Entities that utilize container technologies often prefer that all processes executed in a computing environment be capable of being containerized and run as containers. A container deployment system may comprise any containerization technology or containerization technologies, such as, by way of non-limiting example, Open Shift, Docker, Kubernetes, or the like.

In some instances, the first time series data 14 can be correlated based on one or more temporal spacings. For example, the first time series data 14 can be grouped (e.g., by the computing device 12, etc.) into a plurality of time groups 44-1, 44-2, . . . 44-N based on one or more temporal spacings between neighboring datapoints of each time group 44-1 through-N. As a non-limiting illustrative example, a first time group 44-1 could include all datapoints collected on Sundays at 12:00 AM Greenwich Mean Time. In the illustrative example, neighboring datapoints of the first time group 44-1 are spaced one week apart, corresponding to a weekly temporal spacing. Other temporal spacings are possible (e.g., daily, monthly, quarterly, yearly, etc.).

In some instances, the first time series data 14 can be grouped in more than one way, and a datapoint may belong to more than one group. As an illustrative example, the first time series data 14 can be correlated into a first plurality of groups based on a daily temporal spacing; a second plurality of groups based on a weekly temporal spacing; a third plurality of groups based on a monthly temporal spacing; and so on. However, this is not required. In some instances, a resolution of each datapoint may differ depending on a temporal spacing of a time group 44-1, 44-2, . . . 44-N to which the datapoint belongs. As an illustrative example, a time group 44-1 with a relatively small spacing (e.g., daily, etc.) may have datapoints associated with relatively small time windows (e.g., 30-second window, one-minute window, five-minute window, 30-minute window, etc.), while another time group 44-N may have a larger temporal spacing (e.g., monthly, etc.) and the datapoints of the time group 44-N may have correspondingly larger time windows (e.g., half-hour, one-hour, six-hour, twelve-hour, 24-hour, etc.) compared to a time group 44-1 with a smaller temporal spacing. For example, in some instances, a data item associated with a larger time window can be determined by aggregating (e.g., averaging, summing, etc.) data items associated with smaller time windows. As a non-limiting illustrative example, a data item associated with a 30-minute time window can be determined by averaging usage amounts of 30 data items associated with one-minute time windows.

In some instances, the first time series data 14 can be collected throughout an initial period (e.g., break-in period, probationary period, etc.) associated with the first service instance 18 (e.g., after the first service instance 18 is first defined, initialized, or the like), and an appropriate cluster 20, 26, 46 can be selected based on the initial first time series data 14. In some instances, the first time series data 14 can be continually updated throughout a lifetime of the first service instance 18 (e.g., every 30 seconds, etc.), and a choice of cluster 20, 26, 46 for executing the first service instance 18 can reevaluated one or more times (e.g., periodically reevaluated; reevaluated in response to detection of an event; etc.). In some instances, updating the first time series data 14 can include collecting new data. In some instances, updating the first time series data 14 can include removing one or more existing datapoints from the first time series data 14. For example, a sliding time window (e.g., fixed-width sliding time window, variable-width sliding time window, etc.) can be defined, and older datapoints can be continually removed from the first time series data 14 as new data is collected. For example, a sliding time window can include a fixed-width (e.g., one-week, two-week, one-month, two-month, six-month, etc.) or variable-width sliding time window, and data older than a current width of the sliding time window can be removed (e.g., periodically; after each new datapoint is collected;
before each time the first time series data 14 is used to reevaluate a cluster selection for the first service instance 18; etc.). Removing a datapoint from the first time series data 14 can include deleting, moving, relabeling, or otherwise causing the datapoint to be excluded from the first time series data 14.

In some instances, continual monitoring of first time series data 14 and migration between clusters can include “emergency” or short-term migration in response to a change (e.g., short-term increase, etc.) in usage of one or more computing resources 16-1. Further details of example implementations of short-term migration in response to a change in usage are further provided below.

Computing resources 16-1 can include any hardware resources or other computing resources (e.g., software resources, firmware resources, physical resources, logical resources, etc.) that are available to the first cluster 20 for use in performing a computing operation. For example, computing resource 16-1 can include one or more devices 48, such as a virtual computing devices 48-2 (e.g., virtual machine, container, pod such as Kubernetes pod, etc.) or physical devices 48-1 (e.g., computing device, embedded device, smart device, etc.); processing resources 50 (e.g., processor devices, processor time, processing operations such as floating-point operations, etc.); memory resources 52 (e.g., volatile memory such as RAM; non-volatile or semi-volatile storage resources; etc.); storage resources 54; communication resources (e.g., network resources, input/output resources, etc.); or other computing resource. In some instances, computing resources 16-1 can include computing resources that are expected to be shared between a plurality of processes 56-1 of the first cluster 20 (e.g., processing resources 50, network resource, disk input/output, etc.). Additional example implementation details for an example device 48 are provided below with respect to FIG. 4.

The first service instance 18 can include a service instance executing on the first cluster 20. As used herein, the term “service instance” refers to one or more executing processes that interoperate to provide a desired function. In some instances, a service instance can include one or more service endpoint processes to receive computing requests (e.g., from a user, from a device, etc.) associated with the service instance. In some instances, a service instance can include one or more compute node processes (e.g., containers, pods, etc.) to perform computing operations (e.g., fulfill compute requests, etc.). For example, in some instances, a service instance can include a service endpoint process to receive a plurality of requests to use an application (e.g., containerized application, etc.) from a plurality of users. In some instances, a service instance can include or be associated with one or more control processes (e.g., process of a cluster controller 38, etc.) to allocate one or more compute node processes to each request. However, this is not required. As used herein, a service instance can include any set of one or more executing processes that interoperate to provide a desired function.

A first cluster 20 can include, for example, a cluster of computing devices (e.g., physical computing devices; virtual computing devices such as virtual machines, containers, etc.; or a combination thereof). The first cluster 20 can include one or more cluster controller 38-1 components (e.g., Kubernetes control plane components, Docker control plane components, etc.), and one or more computing resources 16-1 to perform computing operations. At any given time, the first cluster 20 can be executing one or more processes 56-1, including one or more processes of a first service instance 18. The first cluster 20 can also have one or more storage resources 54, such as a database storage resource. In some instances, a storage resource 54 can include a storage resource that is shared between a plurality of devices 48 or plurality of processes 56-1.

Second time series data 22 can have, for example, data indicative of a plurality of amounts of a computing resource 16-2 of the second cluster 26 used by one or more second processes 24. In other respects, second time series data can have any property described above with respect to first time series data 14, and can be obtained in any manner described above with respect to first time series data 14.

The second processes 24 can include any computing process executing on the second cluster 26, including but not limited to any service instance, container, virtual machine, pod, application, or other computing process.

A pod (e.g., Kubernetes pod, etc.) is a logical entity that isolates one or more containers from containers in another pod. A pod is defined via a pod specification which includes information such as an identification of the containers in the pod, the volumes used by the containers in the pod, and the like.

The second cluster 26 can include, for example, a cluster of computing devices that is different from the first cluster 20. In other respects, the second cluster 26 can have any property described above with respect to the first cluster 20, and can behave in any manner described above with respect to the first cluster 20.

A processor 28, memory 30, memory controller 32, storage device 34, and display device 36 can include any device or component (e.g., computing component) to perform the functions of a processor, memory, memory controller, storage device, or display device. Further details of example components of an example computing system are further provided below with respect to FIG. 4.

A cluster controller 38-1 can include, for example, any device, application, or module for controlling a cluster of computing devices. In some instances, a cluster controller 38-1 can include functionality to monitor or control processes 56-1 on the first cluster. In some instances, a cluster controller 38-1 can include functionality to monitor or control computing resources 16-1 on the first cluster 20. In some instances, a cluster controller 38-1 can include one or more components associated with a control plane of a container deployment system (e.g., Kubernetes, etc.). For example, a cluster controller 38-1 can include any component of a Kubernetes control plane (e.g., kube-apiserver, etcd, kube-scheduler, kube-controller-manager, cloud-controller-manager, etc.) or any component to perform cluster control operations, such as cluster control operations of a container deployment system (e.g., API server operations; scheduler operations; backing datastore; controller process such as node controller, job controller, endpoint controller, service controller, route controller, or process to run other controllers; etc.).

Because the cluster controller 38-1 is a component of the first cluster 20, functionality implemented by the first cluster 20 may be attributed to the first cluster 20 generally. Moreover, in examples where the cluster controller 38-1 is implemented by one or more devices 48 of the first cluster 20 (e.g., computing devices, processor devices, etc.), functionality implemented by the cluster controller 38-1 may be attributed to the devices generally. More particularly, in examples where the cluster controller 38-1 is implemented by one or more computing devices of the first cluster 20, functionality implemented by the cluster controller 38-1 may be attributed to the computing devices. Moreover, in examples where the cluster controller 38-1 comprises software instructions that program a processor device of the first cluster 20 to carry out functionality discussed herein, functionality implemented by the cluster controller 38-1 may be attributed herein to the processor device. For example, functionality implemented by the cluster controller 38-1 can be attributed to any cluster control device (e.g., processor device, computing device, etc.) implementing the functionality.

It is further noted that while the computing device 12 and the cluster controller 38-1 are shown as separate devices, in other implementations, the computing device 12 and a cluster controller 38-1 could be implemented on a single device or could be implemented in a greater number of devices than two.

A cluster controller 38-2, 38-3 can have any property described herein with respect to a cluster controller 38-1.

A request 40 can include, for example, any signal or instruction (e.g., message, query, computer code, API call, etc.) to cause a cluster controller 38-1, 38-2, 38-3 to provide cluster data 58 about a cluster 20, 26, 46. Cluster data 58 can include, for example, current usage amounts 42 indicative of a current usage of one or more computing resources 16; computing resource amounts 60 indicative of one or more amounts of one or more computing resources that are available to a cluster 20, 26, 46; or any other data related to a cluster 20, 26, 46 (e.g., past usage amounts; current or past status data, such as device status data; scheduler data; namespace data; etc.).

Current usage amount data 42 can include, for example, any data indicative of an amount of usage of a computing resource 16-1, 16-2, 16-3. For example, current usage amount data 42 can include data indicating an amount of a computing resource 16-1, 16-2, 16-3 currently being used by one or more processes 56-1, 56-2, 56-3; by one or more devices 48; by a cluster 20, 26, 46 as a whole; or other current usage amount data.

The third cluster 46 can include, for example, a cluster of computing devices that is different from the first cluster 20 and second cluster 26. In other respects, the third cluster 46 can have any property described above with respect to the first cluster 20, and can behave in any manner described above with respect to the first cluster 20.

Processes 56-1, 56-2, 56-3 can be any computing process, operation, plurality of operations, or the like being executed by the clusters 20, 26, 46 (e.g., by one or more computing devices or processor devices of the clusters 20, 26, 46 based on one or more machine-readable instructions, etc.).

While for purposes of illustration only a few clusters 20, 26, 46 and processes 56-1, 56-2, 56-3 are illustrated, in operation, a computing system 10 may have dozens, hundreds, or thousands of clusters 20, 26, 46 or processes 56-1, 56-2, 56-3. In some examples, a computing system or clusters 20, 26, 46 can be implemented in a cloud computing environment, such as, by way of non-limiting example, an Amazon Web Services (AWS) or Microsoft Azure cloud computing environment.

In some instances, the computing device 12 can select, based at least in part on the first time series data 14 and second time series data 22, a cluster 20, 26, 46 to execute the first service instance 18. In some instances, selecting a cluster 20, 26, 46 based on time series data 14, 22 can include generating one or more predictions 62 and selecting a cluster 20, 26, 46 based on the predictions 62. For example, selecting a cluster 20, 26, 46 based on time series data 14, 22 can include predicting one or more first future usage amounts 64 associated with the first service instance 18; predicting one or more second future usage amounts 64 associated with the second processes 24; and selecting a cluster 20, 26, 46 for the first service instance 18 based on the first and second predicted future usage amounts 64.

In some instances, the predictions 62 can include a plurality of predictions for a plurality of future times (e.g., one day's worth of future times; one week; one month; etc.). For example, in some instances, a plurality of time groups 44-1 to 44-N of the first time series data 14 may be grouped according to a temporal spacing (e.g., daily, weekly, monthly, etc.), and predictions 62 can be generated for a number of future times corresponding to the temporal spacing. In some instances, a plurality of time groups 44-1 to 44-N may be grouped based on a plurality of temporal spacings, and predictions 62 can be generated for a number of future times corresponding to one of the temporal spacings (e.g., the largest temporal spacing, etc.). As a non-limiting illustrative example, if the first time series data 14 comprises one-minute time-window datapoints and is split into 1440 time groups based on a 24-hour temporal spacing, then a computing device 12 can in some instances generate 1440 predictions associated with 1440 one-minute windows of a 24-hour period. Other implementations are possible. In some instances, each prediction 62 can be correlated with a corresponding time group 44-1 to 44-N based on a temporal spacing of the time group 44-1 to 44-N. As a non-limiting illustrative example, if a first time group 44-1 comprises datapoints collected on Sundays at 12:00 a.m. Greenwich Mean Time, a prediction 62 correlated with the first time group 44-1 can be a prediction 62 associated with a future Sunday at 12:00 a.m. Greenwich Mean Time.

Generating the predictions 62 can include, for example, any method for predicting future data based on past data (e.g., statistical prediction methods, machine-learned prediction methods, etc.). In some instances, the computing system 12 can generate predictions based on statistical aggregation (e.g., mean, median, mode, percentile data, maximum, minimum, geometric mean, etc.). In some instances, the computing system 12 can generate predictions 62 using a machine-learned model. In some instances, the computing system 12 can generate predictions 62 (e.g., using statistical methods, machine learning methods, etc.) based on one or more time groups 44-1 to 44-N.

For example, a computing system 12 using statistical methods can divide the time series data 14, 22 into a plurality of time groups 44-1 to 44-N based on a temporal spacing. For each time group 44-1 to 44-N, the computing system 12 can generate one or more statistical aggregate values (e.g., mean, median, maximum, variance, standard deviation, etc.) associated with the time group 44-1 to 44-N. In some instances, the predictions 62 can be generated by a computing system 12 based at least in part on the statistical aggregate values. In some instances, the predictions 62 can be or comprise the statistical aggregate values. For example, a statistical aggregate value associated with a time group 44-1 to 44-N can comprise a predicted future usage 64 associated with that time group 44-1 to 44-N. Such a predicted future usage 64 can be a predicted future usage at any time point that is spaced from the datapoints of the time group 44-1 to 44-N according to a temporal spacing of the time group (e.g., n days away, n weeks away, etc.). As an illustrative example, if a time group 44-1 has a weekly temporal spacing and comprises datapoints corresponding to 12:00 am on Sundays, then a statistical aggregation associated with the time group 44-1 can be or comprise a prediction 62 associated with any future Sunday at 12:00 am.

As another example, a computing system 12 can use machine learning methods to generate predictions 62 for a plurality of future times. In some instances, a computing system 12 using machine learning can correlate (e.g., subdivide, label, organize, etc.) a plurality of time groups 44-1 to 44-N based on a temporal spacing, and can generate predictions based at least in part on the plurality of time groups 44-1 to 44-N. For example, the computing system 12 can provide the correlated time series data 14, 22 or time groups 44-1 to 44-N to a machine-learned model (e.g., machine-learned sequence processing model such as transformer, convolutional neural network, recurrent neural network, long short-term memory, selective structured state space machine, etc.) and generate, using the machine-learned model, a plurality of predictions 62 for a plurality of future times.

In some instances, one or more predictions 62 can be based at least in part on data other than time series data 14, 22 (e.g., when an amount of available time series data 14, 22 is limited, etc.) For example, a prediction 62 can in some instances be based on data indicative of a maximum usage of a computing resource 16-1, 16-2, 16-3 associated with a process 56-1, 56-2, 56-3 (e.g., according to a service level agreement, etc.); data indicative of a location (e.g., time zone, country, continent, city, internet protocol address, etc.) of one or more users associated with a process 56-1, 56-2, 56-3; or any other data that may be relevant.

In some instances, a first set of predictions 62 associated with the first time series data 14 and a second set of predictions 62 associated with the second time series data 22 can be generated separately. In other instances, a single combined prediction can be generated based on both the first time series data 14 and second time series data 22. For example, the first and second time series data 14, 22 can be combined to generate combined time series data. In some instances, combined time series data can be correlated based on a temporal spacing. In some instances, a computing system 12 can generate one or more combined predictions 62 (e.g., predicted maxima, predicted percentile values, etc.) based at least in part on the combined time series data (e.g., according to statistical methods or machine learning methods as described above).

In some instances, selecting a cluster 20, 26, 46 based on time series data 14, 22 can include comparing predictions 62 (e.g., predicted future usage amounts 64, etc.) associated with the first service instance 18 or second processes 24 to one or more target predicted usages 66 of one or more clusters 20, 26, 46.

A target predicted usage 66 can include, for example, numerical data corresponding to an amount of usage of a computing resource 16-1, 16-2, 16-3. In some instances, a target predicted usage can correspond to a “goal” or “target” amount of predicted usage of a computing resource 16-1, 16-2, 16-3 defining an ideal or optimal allocation of processes 56-1, 56-2, 56-3 to clusters 20, 26, 46. For example, an optimal allocation of processes 56-1, 56-2, 56-3 to a cluster 20, 26, 46 can in some instances be defined as an allocation where a total predicted usage (e.g., sum of predicted usage amounts 64, etc.) of each computing resource 16-1, 16-2, 16-3 of the cluster is equal to (or approximately equal to, as close as possible to, etc.) a corresponding target predicted usage 66 of each computing resource 16-1, 16-2, 16-3.

In some instances, a target predicted usage 66 can be below, equal or approximately equal to, or even above a corresponding computing resource amount 60 indicating a total amount of a computing resource 16-1, 16-2, 16-3 that is available to a cluster 20, 26, 46. For example, in some instances, a target predicted usage 66 may be slightly or somewhat below (e.g., about 5 percent below, about 10 percent below, about 20 percent below, etc.) 100 percent usage of a computing resource amount 60. In this manner, for instance, a percentage of each computing resource 16-1, 16-2, 16-3 can be held in reserve to act as a “buffer” in case of higher-than-predicted usage of the computing resource 16-1, 16-2, 16-3. As an illustrative example, a cluster 20, 26, 46 with 100 processing devices may have a target predicted usage of 90 processing devices at all times to provide a 10-device “buffer” to accommodate surprises or variations in usage.

In some instances, a target predicted usage 66 may be equal to or above a corresponding computing resource amount 60 indicating a total amount of a computing resource 16-1, 16-2, 16-3 that is available to a cluster 20, 26, 46. For example, in some instances, one or more processes 56-1, 56-2, 56-3 can include low-priority processes, wherein ensuring full usage of the computing resources 16-1, 16-2, 16-3 may be more important than ensuring reliable or timely execution of the processes 56-1, 56-2, 56-3. In such instances, a target predicted usage 66 may be above the corresponding computing resource amount 60 to provide a “reverse buffer” of standby processes 56-1, 56-2, 56-3 held in reserve to ensure continuous near-maximum usage of each computing resource 16-1, 16-2, 16-3.

In some instances, a target predicted usage 66 can be determined based on policy data 68. Policy data 68 can include, for example, any data describing policies (e.g., rules, preferences, guidelines, objectives, goals, targets, etc.) for managing (e.g., scheduling, allocating, migrating, controlling, etc.) usage of one or more computing resources 16-1, 16-2, 16-3 by one or more processes 56-1, 56-2, 56-3. Policy data 68 can include, for example, cluster-specific policy data 70 or process-specific policy data such as service instance policy data 72 associated with the first service instance 18. In some instances, process-specific policy data can include a target uptime percentage 74, a total permitted usage amount 76 or availability amount target 78, a threshold usage amount 80 such as a usage amount associated with a usage-throttling threshold or the like, or any other process-specific policy data. In some instances, cluster-specific policy data 70 can include one or more availability amount targets 78 indicative of an amount of each computing resource 16-1, 16-2, 16-3 that should be available to a cluster 20, 26, 46 (e.g., on standby, etc.) at any given time. In some instances, cluster-specific policy data 70 can include one or more uptime percentage targets 74, which can be indicative of a target percentage of time (e.g., minimum percentage, etc.) that an availability amount target 78 should be met. In some instances, policy data 68 can include Kubernetes policy data

(e.g., Resource Quotas, Limit Ranges, Process ID Limits, resource manager policies such as Device Manager, CPU Manager, or Memory Manager Policies), control group policy data (e.g., Linux cgroup policy data such as resource limiting or prioritization data, etc.), or analogous policy data associated with another process deployment system (e.g., container deployment system, virtual machine deployment system, etc.). In some instance, policy data 68 can include data indicative of a service level agreement, service level objective, or other service level policy data.

Determining a target predicted usage 66 based on policy data 68 can include, for example, accessing a data structure comprising the policy data 68 (e.g., retrieving the policy data 68 from the data structure, etc.), such as a data structure correlating one or more processes (e.g., service instances, etc.) with one or more computing resource usage policies; a data structure correlating one or more clusters with one or more computing resource usage policies; or the like. A target predicted usage 66 can be based on one policy data 68 value or multiple policy data 68 values. For example, determining a target predicted usage 66 based on policy data 68 can include retrieving a plurality of policy data values (e.g., uptime percentage target values, available amount target values, etc.) and determining a targeted predicted usage 66 based at least in part on the plurality of policy data values. In some instances, determining a target predicted usage based on policy data 68 can include aggregating a plurality of policy data 68 values to determine an aggregate value (e.g., maximum, minimum, sum, median, etc.). As an illustrative example, process-specific policy data (e.g., service instance policy data 72, etc.) can include an availability amount target 78 value for each of a plurality of processes, and a target predicted usage 66 can be determined based at least in part on a sum of the availability amount target 78 values; a maximum of the plurality of availability amount target 78 values; or other aggregate value. In some instances, a first plurality of policy data 68 values can be aggregated in a first way, and a second plurality of policy data 68 values can be aggregated in a second way. As an illustrative example, a plurality of process-specific policy data 68 values (e.g., availability amount target 78 values, etc.) can be aggregated in a first way (e.g., by taking a sum of the values, etc.), and the aggregated value can be further aggregated with one or more cluster-specific policy data 70 values (e.g., availability amount target 78 values) in a second way (e.g., maximum of the cluster-specific policy data 70 value and the aggregated value, etc.).

In some instances, a target predicted usage 66 can be determined based at least in part on computing resource amount 60 data indicating a total amount of one or more computing resources 16-1, 16-2, 16-3 accessible to a cluster 20, 26, 46. As an illustrative example, a target predicted usage 66 can be determined based on a comparison between one or more availability amount targets 78 and one or more computing resource amounts 60. For example, determining a target predicted usage 66 for a particular computing resource 16-1, 16-2, 16-3 can include subtracting an availability amount target 78 indicative of an amount of the computing resource 16-1, 16-2, 16-3 that should be kept on standby from a computing resource amount 60 indicative of a total amount of the computing resource 16-1, 16-2, 16-3 that is accessible to a cluster 20, 26, 46.

Cluster-specific policy data 70 can include any policy data 68 that applies to one or more identified clusters 20, 26, 46. In some instances, a cluster-specific policy data 70 value can apply to one cluster 20, 26, 46 or many clusters 20, 26, 46. In some instances, cluster-specific policy data 70 can include one or more static (e.g., constant) policy data values, or can be dynamically generated (e.g., based on one or more processes 56-1, 56-2, 56-3 running on the cluster 20, 26, 46; based on policy data 68 associated with the processes 56-1, 56-2, 56-3; etc.).

In some instances, cluster-specific policy data 70 can be derived from process-specific policy data associated with processes 56-1, 56-2, 56-3 already running on a cluster 20, 26, 46, or processes 56-1, 56-2, 56-3 that may be expected to run on the cluster 20, 26, 46 in the future or are being considered for migration to the cluster 20, 26, 46. In some instances, cluster-specific policy data 70 can be determined based on an aggregate value (e.g., statistical aggregate value such as sum, maximum, mean, median, etc.) determined from process-specific policy data of the processes 56-1, 56-2, 56-3. As an illustrative example, each process may be associated with a permitted usage amount 76 indicative of an amount of computing resources 16-1, 16-2, 16-3 the process should have access to if requested by the process. In such instances, an availability amount target 78 for a cluster 20, 26, 46 can be determined based at least in part on one or more computing resource amounts 60 for the cluster 20, 26, 46, and an aggregate value (e.g., sum, maximum, square root of sum, sum of nth root, etc.) determined by aggregating the permitted usage amounts 76.

Service instance policy data 72 can include any process-specific policy data that may apply to the first service instance 18. Process-specific policy data can include data indicative of one or more policies that apply to only one process (e.g., the first service instance), and data indicative of one or more policies that apply to a plurality of processes.

Target uptime percentage 74 can include, for example, data indicative of an amount of time (e.g., percentage of time, such as 99.9 percent, 99 percent, 99.99 percent, 99.95 percent, etc.) that a cluster 20, 26, 46 or process 56-1, 56-2, 56-3 is expected to satisfy one or more conditions (e.g., conditions indicative of the processes 56-1, 56-2, 56-3 working as expected, desired, etc.). For example, a target uptime percentage 74 can include a percentage of time that a cluster 20, 26, 46 is expected to successfully perform a plurality of computing operations associated with a particular process (e.g., first service instance 18, etc.). Successful performance can include performing the operations in a manner that satisfies one or more goals or conditions (e.g., latency targets, throughput targets, percentage-based completion targets, etc.), such as conditions defined in the policy data 68. For example, in some instances, an uptime percentage target can include a target percentage of time that an amount of one or more computing resources 16-1, 16-2, 16-3 available to a particular process (e.g., first service instance 18, etc.) is greater than or equal to a permitted usage amount 76 indicative of an amount of the computing resource 16-1, 16-2, 16-3 that the process is permitted to use; an amount of the computing resource 16-1, 16-2, 16-3 actually requested by the process; or the like. As another example, a target uptime percentage 74 can include a percentage of time that one or more rules or policies (e.g., available amount targets 78, etc.) is met. For example, a target uptime percentage 74 can include a target percentage of time that an amount of a computing resource 16-1, 16-2, 16-3 that is available (e.g., idle, on standby, etc.) is greater than an available amount target 78; a target percentage of time that an amount of a computing resource 16-1, 16-2, 16-3 is expected to be below a target predicted usage 66; or the like.

A total permitted usage amount 76 can include, for example, an amount of one or more computing resources 16-1, 16-2, 16-3 that a particular process 56-1, 56-2, 56-3 is permitted to use or expected to be able to use. For example, a total permitted usage amount 76 can include an amount of the computing resources 16-1, 16-2, 16-3 that are allocated to the process 56-1, 56-2, 56-3; that are guaranteed or expected to be available upon request (e.g., according to a service tier, service contract, service level agreement, service level objective, etc.); that the process 56-1, 56-2, 56-3 is expected to use or request during a peak usage time; etc. In some instances, the total permitted usage amount 76 can include a fixed amount that is applicable to all time periods (e.g., an amount expected to be available at any time a process 56-1, 56-2, 56-3 requests usage of the full permitted usage amount 76, etc.), or a variable amount. In some instances, a cluster 20, 26, 46 may execute a plurality of processes 56-1, 56-2, 56-3 associated with a plurality of permitted usage amounts 76, and a sum of the permitted usage amounts 76 can be greater than a computing resource amount 60 indicative of a total amount of a computing resource 16-1, 16-2, 16-3 available to a cluster 20, 26, 46. This can be referred to in some instances as “oversubscription,” wherein a cluster 20, 26, 46 would be unable to fulfill all requests associated with a plurality of processes 56-1, 56-2, 56-3 if all of the processes requested use of the full permitted usage amounts 76 at the same time. However, when the processes do not use the full permitted usage amounts 76 at the same time (e.g., when predictions 62 indicate different peak usage times for different processes, etc.), then a cluster can in some instances fulfill all requests associated with processes 56-1, 56-2, 56-3 on that cluster, despite being oversubscribed according to a sum of permitted usage amounts 76. In this manner, for instance, a plurality of computing operations (e.g., processes 56-1, 56-2, 56-3) can be performed at reduced cost (e.g., reduced hardware usage, reduced capital cost of hardware, reduced electricity cost, etc.) compared to a fully subscribed (e.g., computing resource amount 60 equal to a sum of permitted usage amounts 76) or undersubscribed (computing resource amount 60 greater than a sum of permitted usage amounts 76) condition.

An availability amount target 78 can include, for example, an amount of one or more computing resources 16-1, 16-2, 16-3 to be kept available (e.g., idle, on standby, etc.) for usage by one or more processes 56-1, 56-2, 56-3 or by a cluster 20, 26, 46 as a whole. In some instances, the availability amount target 78 can be the same as or different from, based on or based in part on, or related to or unrelated to a corresponding total permitted usage amount 76. For example, in some instances, a permitted usage amount 76 can include a fixed amount that is applicable to all time periods and indicative of a total amount of a computing resource 16-1, 16-2, 16-3 expected to be accessible to a process 56-1, 56-2, 56-3 when needed. In some instances, an availability amount target 78 can include a variable amount that may be different at different times (e.g., plurality of availability amount target 78 values applicable to a plurality of times or time groups, etc.), and may be indicative of a standby amount of a computing resource 16-1, 16-2, 16-3 expected to be kept available (e.g., idle, on standby, etc.) as a buffer (e.g., to accommodate unexpectedly high usage, long-term or short-term increases in usage, etc.). In some instances, one or more availability amount targets 78 can be determined based at least in part on one or more permitted usage amounts 76; predictions 62; time series data 14, 22; predicted variations in usage 82; or other data. In some instances, availability amount targets 78 can include process-specific availability amount targets 78 indicative of an amount expected to be kept available for a particular process or plurality of processes 56-1, 56-2, 56-3, or cluster-specific data indicative of an amount expected to be kept available on a particular cluster 20, 26, 46. In some instances, an availability amount target 78 can include a default buffer amount or percentage (e.g., 10 percent of one or more computing resources 16-1, 16-2, 16-3 available to a cluster 20, 26, 46; 5 percent; 20 percent; etc.).

A threshold usage amount 80 can include, for example, one or more usage thresholds. In some instances, a threshold usage amount 80 can be associated with two or more policy configurations (e.g., scheduling rules, migration rules, etc.), wherein a first policy configuration may apply to a process using an amount of a computing resource 16-1, 16-2, 16-3 that is below the usage threshold 80, and a second policy configuration may apply to a process using an amount of a computing resource 16-1, 16-2, 16-3 that is above the threshold. As an illustrative example, a usage threshold 80 can include a throttling threshold, wherein a process 56-1, 56-2, 56-3 is given a high priority (e.g., by a cluster controller 38-1, 38-2, 38-3, etc.) when usage is below the usage threshold 80, and a lower priority when usage is above the usage threshold 80. For example, in some instances, a policy associated with a threshold usage amount 80 can include allocating requested computing resources 16-1, 16-2, 16-3 above the threshold usage amount 80 if they happen to be available, but not allocating the requested resources if one or more other processes (e.g., higher-priority processes) have requested usage of the resources. In some instances, a policy associated with a threshold usage amount 80 can include capping or otherwise limiting a usage amount. In some instances, a policy associated with a threshold usage amount 80 can include migrating a policy to an appropriate cluster 20, 26, 46, such as a cluster designated for processes that exceed a usage threshold 80, a cluster designated for low-priority processes, a throttling cluster, a “noisy neighbors” cluster for processes expected to overuse computing resources 16-1, 16-2, 16-3, etc. For example, a computing device 12 can obtain (e.g., retrieve from a data structure comprising policy data 68, etc.) data indicative of a usage threshold 80 associated with one or more processes (e.g., first service instance 18, etc.); determine that the one or more processes are expected to exceed the usage threshold 80 (e.g., at one time, at all times, at a plurality of times, etc.); and migrate the one or more processes, responsive to the determining, to a cluster (e.g., second cluster 26) executing one or more additional processes (e.g., other processes 24) that are expected to exceed a second usage threshold 80 (e.g., the same as or different from the first usage threshold 80). For example, a throttling cluster or cluster designated for low-priority processes may be a cluster 20, 26, 46 for executing a plurality of processes 56-1, 56-2, 56-3 that are expected to exceed one or more usage thresholds 80. Processes 56-1, 56-2, 56-3 expected to exceed the usage thresholds 80 can comprise some or all of the processes 56-1, 56-2, 56-3 executing on a “noisy neighbors” cluster or the like.

In some instances, process-specific policy data can be shared between a plurality of processes. For example, process-specific policy data can include policy data associated with one or more “default” policies (e.g., plurality of service tiers; plurality of default configurations, such as default latency-critical process settings, default cost-sensitive process settings, etc.; or other policy data 68), wherein a “default” policy can include any policy that applies to a plurality of processes (e.g., plurality of unrelated processes, etc.).

In some instances, selecting a cluster 20, 26 based on time series data 14, 22 can include predicting one or more variations in future usage 82 associated with the first service instance 18 or second processes 24. For example, in some instances, a computing system 12 can select a cluster 20, 26, 46 based on a comparison between one or more predicted variations in future usage 82 and policy data 68 (e.g., uptime percentage targets 74, etc.).

Predicted variations in usage 82 can include, for example, one or more predicted statistical measures of variation, such as standard deviations, variances, confidence intervals, percentile data, and the like. For example, in some instances, a predicted variation in usage 82 can include a percentile value associated with one or more uptime percentage targets 74. As an illustrative example, if policy data 68 indicates that a particular process should have 99 percent uptime, a predicted variation in usage 82 can include a 99th percentile usage value indicative of an amount of one or more computing resources 16-1, 16-2, 16-3 expected to be used by one or more processes 56-1, 56-2, 56-3. An n^{th} percentile value can be an amount of one or more computing resources 16-1, 16-2, 16-3, wherein an amount of the one or more computing resources 16-1, 16-2, 16-3 that is predicted to be used by one or more processes 56-1, 56-2, 56-3 is expected to be less than or equal to the n^{th} percentile value n percent of the time. In some instances, a predicted variation in usage 82 can include one or more values (e.g., standard deviations, etc.) from which a percentile value can be derived or estimated (e.g., based on a Gaussian distribution, etc.). Predicted variations in usage 82 can include statistical predictions, machine-learned predictions, parametric predictions, non-parametric predictions, or other prediction values.

Selecting a cluster 20, 26, 46 based on the predicted variations in usage can include, for example, comparing the predicted variations in usage 82 to one or more uptime percentage targets 74. For example, selecting a cluster 20, 26, 46 to execute the first service instance 18 can include determining, by a computing device 12 based at least in part on an available amount target 78 and a predicted variation in usage 82 associated with a computing resource 16-1, 16-2, 16-3, a target predicted usage 66; and then selecting, based on a comparison between the target predicted usage 66 and one or more predictions 62, a cluster 20, 26, 46 to execute the first service instance.

In some instances, a computing device 12 can implement one or more strategies to provide seamless (e.g., zero-downtime, zero-user-visibility, etc.) migration of the first service instance 18. For example, in some instances, an exposed hostname 84 associated with the first service instance 18 can be independent of a cluster 20, 26, 46 on which the first service instance 18 is running. For example, a data structure can map a plurality of cluster-independent hostname 84 values to corresponding cluster-specific routing information. Routing information can include, for example, a Domain Name System (DNS) value; an internet protocol (IP) address; a port number; or other routing information. Prior to migration of a first service instance 18, the data structure can include data mapping a cluster-independent hostname 84 value of the first service instance 18 to cluster-specific routing information of the first cluster 20. After migration of the first service instance 18, the data structure can include data mapping a cluster-independent hostname 84 value of the first service instance 18 to cluster-specific routing information of the second cluster 26. Responsive to receiving a service request 86, a computing device 12 can retrieve, from the data structure, data mapping a cluster-independent hostname 84 associated with the service request 86 to routing information associated with a cluster 20, 26, 46; and route, based on the data, the service request 86 to the cluster 20, 26, 46. In this manner, for instance, a requester (e.g., user, device, etc.) can submit service requests 86 associated with the first service instance 18 before and after migration, without changing a hostname 84 used by the requester.

As another example, zero-downtime migration of non-database or non-storage functionality of a first service instance 18 can be provided by initiating one or more processes (e.g., pods, containers, etc.) of a migrated service instance 88 on a second cluster 26 before winding down one or more processes of a first service instance 18 running on the first cluster 20. For example, a computing device 12 can initialize one or more processes associated with a migrated service instance 88 on the second cluster; route one or more service requests 86 associated with the first service instance 18, 88 to the processes of the migrated service instance 88; determine that a process on the first cluster 20 associated with the first service instance 18 is idle (e.g., after fulfilling a prior service request 86 or otherwise completing an operation, etc.); and terminate the process on the first cluster 20 responsive to the determining. As used herein, “service request” can include any instruction or request to perform a computing operation associated with a service instance (e.g., network-based request, local instruction, etc.; a request to allocate computing resources 16-1, 16-2, 16-3 to performing an operation; etc.).

In some instances, a number of processes (e.g., pods, containers, etc.) to initiate can be determined based at least in part on policy data 68. For example, a computing system 12 can access a data structure correlating one or more processes 56-1, 56-2, 56-3 to policy data 68 associated with the processes 56-1, 56-2, 56-3; retrieve, from the data structure, policy data 68 associated with the first service instance 18; and initiate one or more processes based on the policy data. For example, a schedule for initiating one or more processes can be selected based on a comparison between policy data 68 and a predicted number of new compute requests 90 expected to be received (e.g., during an initiation time period associated with the migration). As another example, a number of processes selected to be initiated can be a number predicted to be sufficient to satisfy one or more policies of the policy data 68. In some instances, a computing device 12 can route new compute requests 90 associated with the first service 18 or hostname 84 to one or more processes of the migrated service instance 88. In some instances, a computing device 12 or cluster controller 38-1 can wait for processes of the unmigrated first service instance 18 to complete one or more operations (e.g., finish fulfilling one or more pre-migration service requests 86, etc.), and can wind down each process upon completion of the operations. In this manner, for instance, zero-downtime or near-zero-downtime fulfillment of compute requests 90 associated with the first service instance 18 can be achieved.

As another example, zero-downtime migration of database functionality of a first service instance 18 can be provided by a database message queue 92. For example, in some instances, migrating a database 94-1, 94-2 associated with the first service instance 18 from a first cluster 20 to a second cluster 26 may require a significant amount of time. In some instances, a first service instance 18 may require database interactions to be synchronous, meaning that database reads and writes must be paused while the database 94-1, 94-2 is being copied from the first cluster to the second cluster. In such instances, a database message queue 92 can provide zero-downtime or near-zero-downtime migration of database functionality. For example, a computing device 12 can initiate migration by initiating a copying operation to copy a database 94-1 associated with the first service instance 18 from the first cluster 20 to the second cluster 26. During the copying operation, the computing device 12 can receive one or more database read/write requests 96 associated with the first service instance 18. Responsive to receiving a database read/write request 96 during the copying operation, the computing device 12 can route the database read/write request 96 to a database message queue 92. Upon completion of the copying operation, the computing device 12 can process the database message queue 92 on a first-in-first-out basis, routing each database read/write request 96 to the migrated database 94-2 in the order the requests were originally received. During processing of the database message queue 92, the computing device 12 can continue to route new database read/write requests 96 to the database message queue 92 until the database message queue 92 is empty. After the database message queue 92 is fully processed (e.g., empty, etc.), the database read/write requests 96 can be routed directly to the migrated service instance 88 or migrated database 94-2. In this manner, for instance, a first service instance 18 can be seamlessly migrated in a manner that complies with policy data 68 of the first service instance 18 and may be invisible from the point of view of a requester (e.g., user, etc.).

In some instances, the computing device 12 or cluster controller 38-1, 38-2, 38-3 can reallocate processes 56-1, 56-2, 56-3 or computing resources 16-1, 16-2, 16-3 in response to changes or surprises in actual usage of computing resources 16-1, 16-2, 16-3 of one or more processes 56-1, 56-2, 56-3. For example, in some instances, a cluster controller 38-1, 38-2, 38-3 can autoscale a process 56-1, 56-2, 56-3 in response to changes in usage by the process 56-1, 56-2, 56-3. As another example, in some instances, a computing device 12 can migrate (e.g., on a short-term, temporary, or emergency basis; on a permanent basis; etc.) the process 56-1, 56-2, 56-3 in response to changes or surprises in usage by the process 56-1, 56-2, 56-3. For example, in some instances, resource allocations can be adjusted according to a two-stage adjustment process, wherein a first amount of “buffer” resources (e.g., computing resources 16-1, 16-2, 16-3 kept idle, on standby, etc.) is kept available to provide room for autoscaling within the cluster, and a computing device 12 can migrate processes between clusters when a buffer amount is insufficient.

Autoscaling can include, for example, any change to an allocation (e.g., scheduling, assignment, routing, etc.) of computing resources 16-1, 16-2, 16-3 within a cluster to processes 56-1, 56-2, 56-3 within the cluster, wherein the allocation is determined automatically by a computing device 12 or cluster controller 38-1, 38-2, 38-3. In some instances, autoscaling can include changing (e.g., increasing, decreasing, scaling, etc.) a number of devices (e.g., physical devices such as computing devices, processor devices, etc.; virtual devices such as containers, pods, virtual machines, etc.) allocated to a particular process (e.g., first service instance 18). In some instances, autoscaling can include initiating one or more devices (e.g., pods, containers, etc.) to be used by a process 56-1, 56-2, 56-3 responsive to an increase in usage of a computing resource 16-1, 16-2, 16-3 by the process 56-1, 56-2, 56-3 or responsive to an increase in a number of service requests 88 received in association with the process 56-1, 56-2, 56-3.

Migrating a process 56-1, 56-2, 56-3 in response to a change or surprise in usage can include, for example, monitoring usage amounts for a plurality of processes; determining, by a computing device 12, that a usage amount (e.g., total usage amount, usage amount by a particular process, etc.) exceeds a threshold; and migrating, responsive to the determining, one or more processes 56-1, 56-2, 56-3. In some instances, the threshold can be determined based in part on an available amount target 78 or similar “buffer” amount, such as a buffer amount associated with a two-stage buffer. A two-stage buffer can include, for example, a first available amount target 78 associated with an amount of a computing resource that should be available when a total usage amount is equal to a predicted usage amount (e.g., sum of predictions 62, etc.). A two-stage buffer can include, for example, a second available amount target 78 (e.g., maximum permissible usage before migration is required, etc.) indicative of an amount of a computing resource 16-1, 16-2, 16-3 that should be kept available at all times (e.g., when actual usage exceeds predicted usage). As an illustrative example, a two-stage buffer may be associated with a target predicted usage 66 of 90 percent to allow a 10-percent buffer for autoscaling processes when actual usage exceeds predicted usage; and an emergency migration threshold of 98 percent, wherein a computing device 12 begins migrating processes 56-1, 56-2, 56-3 when usage exceeds 98 percent, thereby threatening a cluster's ability to sufficiently autoscale to match potential further increases in usage.

In some instances, a computing device 12 can migrate a process in response to changes in usage on a temporary or permanent basis; short-term or long-term basis; emergency or pre-planned basis; etc. For example, a computing device 12 can migrate a first service instance 18 on a temporary basis in response to actual usage exceeding a threshold (e.g., as described above). As another example, a computing device 12 can migrate a first service instance 18 from a first cluster 20 to a second cluster 26; continue monitoring usage of computing resources 16-1, 16-2, 16-3 by processes 56-1, 56-2, 56-3 including the migrated service instance 88; and, responsive to changes in usage by one or more process 56-1, 56-2, 56-3, further migrate the first service instance 18 to a third cluster 46 or back to the first cluster 20. This further migration can be based, for example, on updated predictions 62; updated policy data 68; updated target predicted usages 66; updated time series data 14, 22; or the like. The further migration can be performed, for example, in a manner described above with respect to the first migration. As another example, a computing device 12 can repeatedly (e.g., two or more times, periodically such as two or more times per day, etc.) migrate a first service 18 between a plurality of clusters 20, 26, 46 on a pre-planned basis based on a plurality of predictions 62, target predicted usages 66, and the like. For example, a computing device 12 may determine that a “best fit” cluster for a first service instance 18 is the second cluster 26 at a first plurality of times, and that the “best fit” cluster for the first service 18 at a second plurality of times is a different cluster 20, 46. Based on the determining, the computing device can intelligently schedule repeated migration of the first service instance 18 such that the first service instance 18 runs on the second cluster 26 at the first plurality of times, and one the different cluster 20, 46 at the second plurality of times.

In some instances, a computing device 12 can partially migrate a first service instance 18 (e.g., on a temporary or short-term basis). Partial migration can include, for example, exposing a cluster-independent hostname 84; initiating one or more processes on a new cluster 20, 26, 46; routing some new compute requests 90 to the new cluster 20, 26, 46 (e.g., and routing some new compute requests 90 to the cluster 20, 26, 46 on which the first service instance 18 is already executing); and routing database read/write requests 96 according to a database message queue 92, such that a single synchronous database can be stored on one cluster 20, 26, 46 and shared (e.g., on a temporary basis) between two or more clusters.

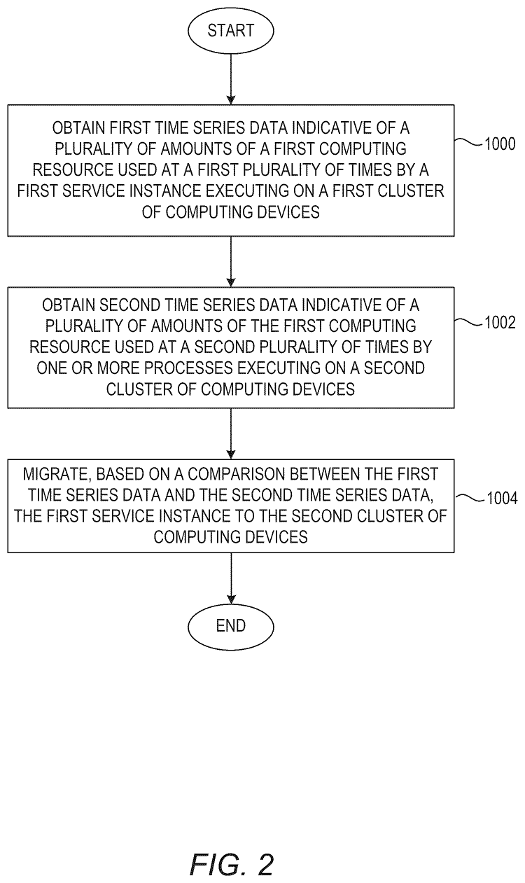

FIG. 2 is a flow chart diagram of an example method for migrating a service instance according to one example. The method of FIG. 2 can be performed, for example, by a computing system 10.

At 1000, a computing system 10 can obtain first time series data (e.g., first time series data 14) indicative of a plurality of amounts of a computing resource (e.g., computing resource 16-1) used at a first plurality of times by a first service instance (e.g., first service instance 18) executing on a first cluster of computing devices (e.g., first cluster 20). Obtaining can include, for example, retrieving (e.g., from memory), receiving (e.g., over a network), opening, reading, and the like.

At 1002, the computing system 10 can obtain second time series data (e.g., second time series data 22) indicative of a plurality of amounts of the computing resource (e.g., computing resources 16-2 corresponding to the same type of computing resource as the computing resource at 1000) used at a second plurality of times (e.g., the same as or different from the first plurality of times) by one or more processes (e.g., other processes 24) executing on a second cluster of computing devices (e.g., second cluster 26).

At 1004, the computing system 10 can migrate, based on a comparison between the first time series data and second time series data, the first service instance to the second cluster of computing devices. Migrating based on the comparison can include, for example, one or more activities described above with respect to FIG. 1 (e.g., selecting a cluster based on the comparison; making predictions 62 based on the time series data; comparing predictions 62 to target predicted usages 64 or policy data 68; etc.).

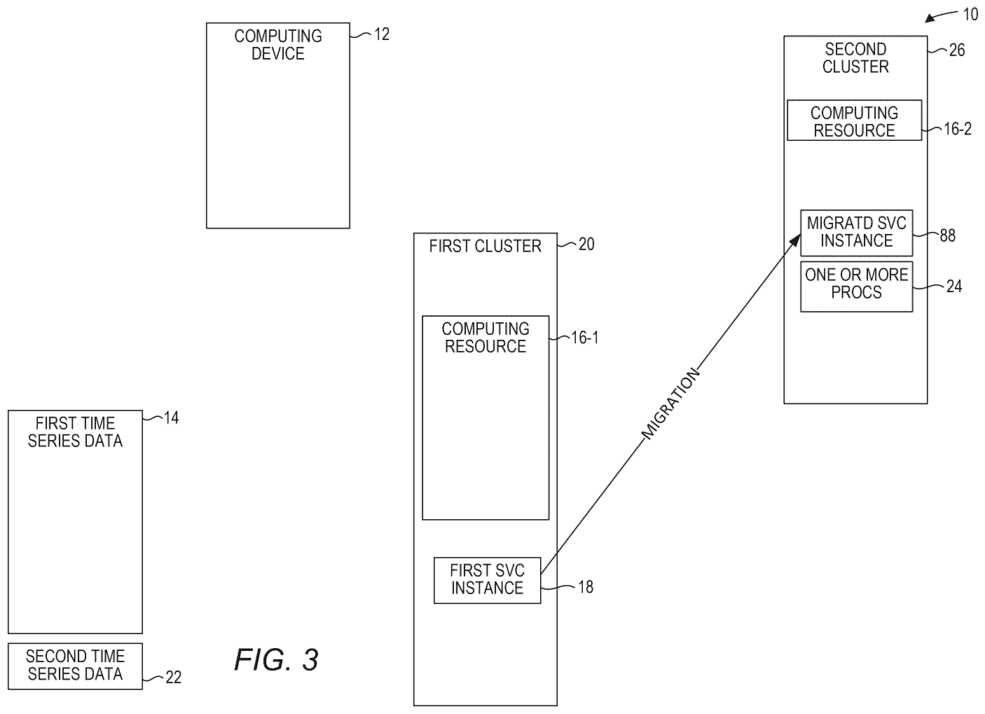

FIG. 3 is a block diagram of a computing system suitable for implementing migration of a service instance according to one example. The computing system 10 may comprise one or more computing devices 12. The computing system 10 can obtain first time series data 14 and second time series data 22 indicative of a plurality of amounts of a computing resource 16-1, 16-2 used at a plurality of times by a first service instance 18 running on a first cluster 20 and one or more processes 24 running on a second cluster 26. Based on a comparison between the first time series data 14 and second time series data 22, the computing system 10 can migrate the first service instance 18, 88 from the first cluster 20 to the second cluster 26.

In some implementations, the parts depicted in FIG. 3 can be, comprise, be comprised by, share similar (e.g., same) properties or operate in a manner similar to (e.g., same as) one or more examples set forth in the description of FIG. 1 with respect to parts sharing a similar (e.g., same) name and part number.

FIG. 4 is a block diagram of the computing device 430 suitable for implementing examples according to one example. The computing device 430 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 430 includes the processor device 432, the system memory 450, and a system bus 446. The system bus 446 provides an interface for system components including, but not limited to, the system memory 450 and the processor device 432. The processor device 432 can be any commercially available or proprietary processor.

In some instances, the computing device 430 can be, comprise, be comprised by, or otherwise share one or more properties with a computing device 12 or device 48. For example, a computing device 12 or device 48 can have any property described herein with respect to a computing device 430.

The system bus 446 may be any of several types of bus structures that may further interconnect to a memory bus (with or without a memory controller), a peripheral bus, and/or a local bus using any of a variety of commercially available bus architectures. The system memory 450 may include non-volatile memory 480 (e.g., read-only memory (ROM), erasable programmable read-only memory (EPROM), electrically erasable programmable read-only memory (EEPROM), etc.), and volatile memory 470 (e.g., random-access memory (RAM)). A basic input/output system (BIOS) 482 may be stored in the non-volatile memory 480 and can include the basic routines that help to transfer information between elements within the computing device 430. The volatile memory 470 may also include a high-speed RAM, such as static RAM, for caching data.

The computing device 430 may further include or be coupled to a non-transitory computer-readable storage medium such as the storage device 454, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 454 and other drives associated with computer-readable media and computer-usable media may provide non-volatile storage of data, data structures, computer-executable instructions, and the like.

A number of modules can be stored in the storage device 454 and in the volatile memory 470, including an operating system 456 and one or more program modules, such as a migration module 472, which may implement the functionality described herein in whole or in part. All or a portion of the examples may be implemented as a computer program product 458 stored on a transitory or non-transitory computer-usable or computer-readable storage medium, such as the storage device 454, which includes complex programming instructions, such as complex computer-readable program code, to cause the processor device 432 to carry out the steps described herein. Thus, the computer-readable program code can comprise software instructions for implementing the functionality of the examples described herein when executed on the processor device 432. The processor device 432, in conjunction with the migration module 472 in the volatile memory 470, may serve as a controller, or control system, for the computing device 430 that is to implement the functionality described herein. An operator, such as a user, may also be able to enter one or more

configuration commands through a keyboard (not illustrated), a pointing device such as a mouse (not illustrated), or a touch-sensitive surface such as a display device. Such input devices may be connected to the processor device 432 through an input device interface 460 that is coupled to the system bus 446 but can be connected by other interfaces such as a parallel port, an Institute of Electrical and Electronic Engineers (IEEE) 1394 serial port, a Universal Serial Bus (USB) port, an IR interface, and the like. The computing device 430 may also include the communications interface 462 suitable for communicating with the network (e.g., internet, etc.) as appropriate or desired. The computing device 430 may also include a video port to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a computing system comprising one or more computing devices, first time series data indicative of a plurality of amounts of a first computing resource used at a first plurality of times by a first service instance executing on a first cluster of computing devices;
obtaining, by the computing system, second time series data indicative of a plurality of amounts of the first computing resource used at a second plurality of times by one or more first processes executing on a second cluster of computing devices; and
migrating, by the computing system based on a comparison between the first time series data and the second time series data, the first service instance to the second cluster of computing devices.

2. The method of claim 1, wherein migrating based on the comparison comprises:
predicting, based on the first time series data, a plurality of amounts of the first computing resource that will be used by the first service instance at a plurality of future times to generate a first plurality of predictions;
predicting, based on the second time series data, a plurality of amounts of the first computing resource that will be used by the one or more first processes at each of the plurality of future times to generate a second plurality of predictions; and
migrating, by the computing system based on a comparison between the first plurality of predictions and the second plurality of predictions, the first service instance to the second cluster of computing devices.

3. The method of claim 2, wherein migrating based on the comparison between the first plurality of predictions and second plurality of predictions comprises:
obtaining, by the computing system, data indicative of a target predicted usage of the first computing resource on the second cluster of computing devices; and
determining, by the computing system based on the first plurality of predictions, the second plurality of predictions, and the target predicted usage, that the first service instance can be migrated to the second cluster of computing devices without exceeding the target predicted usage.

4. The method of claim 3, wherein obtaining the data indicative of the target predicted usage comprises:
retrieving, by the computing system from a data structure correlating a plurality of service instances to a plurality of corresponding policies, policy data associated with the first service instance, wherein the policy data comprises a target availability level;
obtaining, by the computing system, data indicative of an amount of the first computing resource that is accessible to the second cluster of computing devices; and
determining, by the computing system based at least in part on the target availability level and the data indicative of the amount of the first computing resource that is accessible to the second cluster of computing devices, the target predicted usage.

5. The method of claim 4, wherein:
the policy data comprises a target percentage of time that an availability of the first computing resource is above the target availability level;
at least one prediction of the first plurality of predictions and the second plurality of predictions comprises a predicted variation of usage of the first computing resource; and
determining the target predicted usage comprises:
determining, by the computing system based at least in part on the target availability level and the predicted variation of usage of the first computing resource, the target predicted usage.

6. The method of claim 2, wherein predicting the plurality of amounts of the first computing resource that will be used by the first service instance at the plurality of future times comprises:
determining, by the computing system, a plurality of correlated data points of the first time series data based on a temporal spacing between neighboring data points of the plurality of correlated data points; and
predicting, by the computing system based on the plurality of correlated data points, a resource usage amount associated with at least one future time of the plurality of future times, wherein the at least one future time is correlated with the plurality of correlated data points based on the temporal spacing.

7. The method of claim 6, wherein the temporal spacing comprises a 24-hour spacing.

8. The method of claim 6, wherein the temporal spacing comprises a seven-day spacing.

9. The method of claim 2, wherein predicting the plurality of amounts of the first computing resource that will be used by the first service instance at the plurality of future times comprises:
correlating, by the computing system based on a first temporal spacing, a first future time of the plurality of future times with a first plurality of data points of the first time series data;
correlating, by the computing system based on a second temporal spacing, the first future time of the plurality of future times with a second plurality of data points of the first time series data; and
predicting, by the computing system based at least in part on the first plurality of data points and the second plurality of data points, an amount of the first computing resource that will be used by the first service instance at the first future time.

10. The method of claim 2, wherein migrating based on the comparison comprises:
obtaining, by the computing system, first policy data indicative of an amount of the first computing resource that the first service instance is permitted to use;
obtaining, by the computing system, second policy data indicative of an amount of the first computing resource that the one or more first processes are permitted to use; and
migrating, by the computing system based on a comparison between the first plurality of predictions, the second plurality of predictions, the first policy data, and the second policy data, the first service instance to the second cluster of computing devices;
wherein a sum of the amount of the first computing resource that the first service instance is permitted to use and the amount of the first computing resource that the one or more first processes are permitted to use is greater than an amount of the first computing resource available to the second cluster of computing devices.

11. The method of claim 2, wherein migrating based on the comparison comprises:
obtaining, by the computing system, policy data indicative of a first usage threshold associated with the first service instance;
determining, by the computing system based on the first plurality of predictions, that the first service instance is expected to exceed the usage threshold; and
migrating, by the computing system responsive to the determining, the first service instance to the second cluster of computing devices, wherein the one or more first processes comprise a process that is expected to exceed a second usage threshold.

12. The method of claim 1, wherein obtaining the first time series data comprises:
requesting, by the computing system at each of the first plurality of times, resource usage data from a cluster control device associated with the first cluster of computing devices;
receiving, by the computing system from the cluster control device, the resource usage data; and
storing, by the computing system, the resource usage data.

13. The method of claim 1, further comprising:
obtaining, by the computing system after the migrating, data indicative of a current usage amount of the first service instance after the migrating; and
scaling, by the computing system based on the data indicative of the current usage amount, an amount of a second computing resource allocated to the first service instance.

14. The method of claim 13, wherein scaling the amount comprises allocating one or more containers to the first service instance.

15. The method of claim 1, further comprising:
obtaining, by the computing system, policy data indicative of a maximum permissible usage of a second computing resource on the second cluster of computing devices;
obtaining, by the computing system after the migrating, current usage data indicative of an amount of the second computing resource currently being used by the second cluster of computing devices; and
migrating, based on a comparison between the maximum permissible usage and the current usage data, the first service instance to a third cluster of computing devices.

16. The method of claim 1, wherein migrating comprises:
initializing, by the computing system on the second cluster of computing devices, one or more second processes associated with the first service instance;
routing, by the computing system, one or more requests associated with the first service instance to the one or more second processes;
determining, by the computing system, that a third process associated with the first service instance executing on the first cluster of computing devices is idle; and
terminating, by the computing system responsive to the determining, the third process.

17. The method of claim 1, wherein migrating the first service instance comprises:
initializing, by the computing system, a database message queue;
receiving, by the computing system, one or more database write requests associated with the first service instance;
adding, by the computing system, the one or more database write requests to the database message queue;
copying, by the computing system, a database from the first cluster of computing devices to the second cluster of computing devices; and
processing, by the computing system after the copying, the database message queue.

18. The method of claim 1, further comprising:
exposing, by the computing system, a hostname associated with the first service instance;
associating, by the computing system before the migrating, the hostname with the first cluster of computing devices; and
associating, by the computing system after the migrating, the hostname with the second cluster of computing devices.

19. A computing system comprising:
one or more computing devices to:
obtain first time series data indicative of a plurality of amounts of a first computing resource used at a first plurality of times by a first service instance executing on a first cluster of computing devices;
obtain second time series data indicative of a plurality of amounts of the first computing resource used at a second plurality of times by one or more first processes executing on a second cluster of computing devices; and
migrate, based on a comparison between the first time series data and the second time series data, the first service instance to the second cluster of computing devices.

20. A non-transitory computer-readable storage medium that includes executable instructions to cause one or more processor devices to:
obtain first time series data indicative of a plurality of amounts of a first computing resource used at a first plurality of times by a first service instance executing on a first cluster of computing devices;
obtain second time series data indicative of a plurality of amounts of the first computing resource used at a second plurality of times by one or more first processes executing on a second cluster of computing devices; and
migrate, based on a comparison between the first time series data and the second time series data, the first service instance to the second cluster of computing devices.
